(19) United States
(12) Patent Application Publication
(10) Pub. No.: US 2025/0182595 A1
(43) Pub. Date: Jun. 5, 2025

(54) Evacuation System

(71) Applicant: Gabes Limited, New Territories (HK)

(72) Inventors: Ho Yin Wong, New Territories (HK); Ming Chi Wong, New Territories (HK)

(21) Appl. No.: 18/526,306

(22) Filed: Dec. 1, 2023

(51) Int. Cl. G08B 5/36; G01C 21/20

(52) U.S. Cl. CPC G08B 5/36; G01C 21/206

(57) ABSTRACT

An automated evacuation system for guiding people out of a building during an evacuation, the evacuation system including a plurality of sensors at predefined locations in a building, each of the sensors configured to measure hazard parameters, a plurality of emergency signs at predetermined locations within the building, an evacuation server operatively coupled to the plurality of sensors and the emergency signs, the evacuation server configured to receive sensor measurements from each of the sensors, determine if a hazard has occurred based on comparing if one or more of the hazard parameters within the sensor measurements exceeds a threshold, determine a location of the detected hazard, calculate an evacuation path if a hazard has occurred, wherein the evacuation path is a path to out of the building, and control the one or more emergency signs to guide people along the calculated evacuation path.

### TECHNICAL FIELD

The present invention relates to an evacuation system for guiding people out of a building in response to a detected hazard or hazardous situation.

### BACKGROUND

Most buildings include sensors and emergency signs located throughout these buildings to respond to hazardous situations. It is a legal requirement for large buildings e.g., schools, apartment buildings, hospitals or any other public buildings to have emergency signs that point to exits of the building. Additionally, it is a legal requirement for certain types of buildings, especially in public, commercial or industrial buildings, to have sensors to detect fire e.g., smoke alarms and additional sprinkler systems. The alarms and emergency signs may be considered an evacuation system.

These existing evacuation systems are passive evacuation systems. Currently used emergency signs are static signs. These emergency signs simply point in the direction of the closest exit. FIG. 1 and FIG. 2 illustrate examples of current emergency signs. These existing signs are static signs and only display the direction or location of the emergency exit. Currently used sensors in evacuation systems are simple sensors. Examples of commonly used sensors are smoke alarms or fire sprinklers that are binary in operation. These fire sprinklers include a mechanical sensor that trip when the temperature exceeds a threshold and are thus binary in operation. Current smoke alarms simply detect smoke and trip an alarm and/or sprinklers if the detected smoke exceeds a threshold.

These existing evacuation systems of static emergency signs and known sensors are inefficient. These systems are often inefficient in emergency situations. The static signs also provide an unclear evacuation path, and do not guide people away from a hazard e.g., a fire. The sensors being binary can often lead to false alarms or false positives. For example, false fire alarms occur often. This can be frustrating and lead to loss of trust in evacuation systems.

### SUMMARY OF THE INVENTION

The present invention relates to an automated evacuation system for guiding people out of a building in response to a detected hazard, while avoiding hazards within the building. The evacuation system comprises a plurality of dynamically adjustable emergency signs that are controlled to direct people out of a building while avoiding detected hazards in the building during an evacuation. The presently described automated evacuation system provides an improved evacuation system that can safely guide people away from a detected hazard.

In one aspect the present invention relates to an automated evacuation system for guiding people out of a building during an evacuation, the evacuation system comprising:
a plurality of sensors at predefined locations in a building, each of the sensors configured to measure hazard parameters,
a plurality of emergency signs at predetermined locations within the building,
an evacuation server operatively coupled to the plurality of sensors and the emergency signs, the evacuation server configured to:
   receive sensor measurements from each of the sensors,
   determine if a hazard has occurred based on comparing if one or more of the hazard parameters within the sensor measurements exceeds a threshold,
   determine a location of the detected hazard,
   calculate an evacuation path if a hazard has occurred, wherein the evacuation path is a path to out of the building,
   control the one or more emergency signs to guide people along the calculated evacuation path.

In one example the evacuation server may be configured to selectively actuate or control one or more emergency signs to guide people along the calculated evacuation path. In another example, the evacuation server may be configured to control all the emergency signs to guide people along the calculated evacuation path.

In one example each emergency sign comprises comprising controllable indicia to guide people, wherein the evacuation server is configured to transmit control signals to each emergency sign to activate the indicia to indicate a direction of travel corresponding to the calculated evacuation path.

In one example the evacuation system comprises a plurality of sensors, and the sensors are arranged at predefined locations in the building and define a mesh network. The sensors are configured to communicate with the evacuation server wirelessly. The sensors may be configured to communicate directly with the evacuation server or may communicate with the server via other sensors.

In one example the sensors are configured to wirelessly communicate with each other and the evacuation server, wherein the sensors are configured to communicate with each other using the LoRA protocol.

In one example the evacuation server is configured to:
access or generate an electronic model of the building, wherein the model includes the sensors and the emergency signs and their respective locations,
the model further including one or more exits of the building,
calculate an evacuation path through the building to the one or more exits using the model of the building.

In one example the evacuation server is configured to plot the location of one or more detected hazards on the model and calculate an evacuation path to avoid the hazards.

In one example the evacuation server is configured to calculate a plurality of evacuation paths to an exit while avoiding one or more detected hazards in the building.

In one example the evacuation server may comprise:
a sensor gateway configured to receive sensor measurements comprising a hazard parameter,
a hazard detection engine configured to process the sensor measurements and detect a hazard if the one or more measured hazard parameters exceeds a threshold or if one or more measured hazard parameters are trending to exceeding a threshold,
a hazard location engine configured to determine the location of a hazard within the building,
an evacuation path determination module configured to calculate the evacuation path that avoids the hazard location,
a sign actuation engine configured to generate actuation signals that are transmitted to the emergency signs to activate and control the emergency signs to guide people along the calculated evacuation path.

In one example the evacuation path determination module is configured to calculate the evacuation path is calculated based on a shortest point algorithm between the various emergency signs, wherein each emergency sign defines a waypoint in the evacuation path.

In one example the evacuation path determination module is configured to dynamically update the evacuation path and control the emergency signs to guide people along the updated evacuation path.

In one example the hazard location engine is configured to determine a location of the hazard by identifying the one or more sensors that detected the hazard and identifying the location of the one or more sensors, wherein the location of the hazard corresponds to the location of the sensors that detected the hazard.

In one example the system comprises:
a building model database configured to store one or more building models, wherein the building model comprises an electronic or virtual building model,
a sensor location database that includes the locations of each sensor in the building,
an emergency sign location database that includes the location of each emergency sign in the building, and;
wherein the model comprises the locations of the sensors and the emergency signs.

In one example each sensor may include a location identifier stored in the sensor. The sensor may be configured to communicate the location identifier of that sensor to the evacuation server. Each emergency sign may include location data, and the evacuation server may be configured to selectively control one or more emergency signs based on the location data of each emergency sign and the detected hazard location.

In one example the evacuation server is configured to generate a model of the building by accessing one or more building plans and by accessing and utilising the locations of the sensors from the sensor location database and the locations of the emergency signs from the emergency sign location database.

In one example the evacuation server is configured to determine if a hazard has occurred based on one or more of:
a hazard parameter exceeds a threshold,
a hazard parameter is detected for a threshold time or detected for longer than a threshold time,
a hazard parameter exceeds a threshold for at least a threshold time,
a hazard parameter exceeds a threshold within a threshold time,
a rate of change of the hazard parameter.

In one example the rate of change may be the rate of increase of the hazard parameter. The rate of increase may correspond to the increase in concentration. The hazard parameter exceeding a threshold may correspond to the absolute value exceeding a threshold or if the concentration exceeds a threshold.

In one example the evacuation server is configured to:
monitor the location of the detected hazard,
determine if the hazard has moved to another location or a hazard is detected is at another location within the building,
update the evacuation path or calculate a new evacuation path that avoids the location of the detected hazards.

In one example the evacuation server is configured to:
continuously detect hazard parameters from each sensor,
calculate if a hazard has occurred,
monitor the location of the detected hazard and track the spread of the hazard through the building based on the locations of the sensors that have detected hazard parameters indicative of a hazard,
continuously update the evacuation path to avoid the detected hazard and avoid the changing location of the hazard,
continuously control each of the emergency signs to guide people along the updated evacuation path.

In one example the system operates in real time to receive sensor measurements and determine a hazard or predict a hazard is likely to occur, determine an evacuation path in response if an evacuation is required due to a determined hazard or a prediction of a hazard will occur based on the sensor measurements.

In one example the evacuation server may be configured to extrapolate multiple hazard parameter measurements from one sensor to determine if the measured hazard parameters will result in a hazard occurring. The evacuation server may determine if a hazard has occurred if the measured hazard parameter or parameters exceeds a threshold, or the hazard parameter is detected for a threshold time or if the detected hazard parameter exceeds a threshold for a threshold time, or if the hazard parameter exceeds a threshold within a threshold time or based on the rate of change or the hazard parameter.

In one example the evacuation server is configured to:
predict a path of a hazard through the building by extrapolating two or more hazard parameter readings from two or more sensors,
update the evacuation path to avoid locations along the predicted path of the hazard,
control the emergency signs to guide people along the updated evacuation path.

In one example the hazard parameter sensed by the one or more sensors are one or more of:
temperature,
smoke,
gas,
toxic chemicals, or
heat flux.

In one example the evacuation server is configured to:
detect one or more hazard parameters,
determine if the detected hazard parameter has reached a dangerous level,
update the evacuation path to avoid the location of the sensor that detected the hazard parameter has reached a dangerous level,
control the emergency signs to guide people along the updated evacuation path.

In another aspect the present invention relates to an evacuation method for guiding people out of a building during an evacuation, the evacuation method comprising:
receiving sensor measurements from each of the sensors,
determining if a hazard has occurred based on comparing if one or more of the hazard parameters within the sensor measurements exceeds a threshold,
determining a location of the detected hazard,
calculating an evacuation path if a hazard has occurred, wherein the evacuation path is a path to out of the building,
controlling the one or more emergency signs to guide people along the calculated evacuation path.

In one example the method comprises the additional steps of:
accessing or generating an electronic model of the building, wherein the model includes the sensors and the emergency signs and their respective locations,
the model further including one or more exits of the building,
calculating an evacuation path through the building to the one or more exits using the model of the building,
controlling the emergency signs to guide people along the calculated evacuation path.

In one example the method comprises the additional steps of:
monitoring the location of the detected hazard,
determining if the hazard has moved to another location or a hazard is detected is at another location within the building,
updating the evacuation path or calculate a new evacuation path that avoids the location of the detected hazards.

In one example the method comprises the steps of:
continuously detecting hazard parameters from each sensor,
calculating if a hazard has occurred,
monitoring the location of the detected hazard and track the spread of the hazard through the building based on the locations of the sensors that have detected hazard parameters indicative of a hazard,
continuously updating the evacuation path to avoid the detected hazard and avoid the changing location of the hazard,
continuously controlling each of the emergency signs to guide people along the updated evacuation path.

In another aspect the present invention relates to an automated evacuation system for guiding people out of a building comprising:
one or more sensors adapted to measure one or more hazard parameters in the building,
one or more emergency signs disposed within the building,
an evacuation server operatively coupled to the one or more sensors and the one or more emergency signs
the evacuation server is configured to:
   determine the presence of or estimate the possible presence of a hazard in the building based on the measured hazard parameters,
   determine evacuation is required based on the presence of a hazard,
   if evacuation is required, control the emergency signs to guide people out of the building while avoiding the detected hazard.

In one example the evacuation server is configured to:
determine the location of the hazard or possible presence of a hazard within the building,
plan an evacuation route of the building, wherein the evacuation route is planned to avoid the location of the hazard,
operate the emergency signs to visually and/or audibly indicate a direction of travel to avoid the detected hazard, wherein the emergency signs are controlled to indicate the evacuation route.

The evacuation server is configured to transmit control signals to each of the emergency signs to cause the emergency signs to indicate a portion of the evacuation route. Each sign defines a node of an evacuation route. In one example, each emergency sign is controlled to indicate a safe direction of travel for persons, wherein the safe direction is a direction that avoids the detected hazard.

The evacuation server is configured to continuously receive measurements from the sensors and calculate the presence or the possible presence of a hazard. A hazard may be any event that may require an evacuation. For example, the hazard detected by the evacuation server may be one or more of: fire, high smoke concentration, gas leak, sewage leak or any other event that may require an evacuation.

In one example the system comprises a plurality of sensors disposed at predefined locations within the building and each sensor arranged in wireless communication with the evacuation server and;
wherein the plurality of sensors is adapted to communicate with each other and the evacuation server, wherein the sensors form a mesh network of sensors within the building.

In one example the emergency signs are disposed at predefined locations within the building,
each emergency sign comprises a plurality of controllable indicia, and;
wherein the indicia are controlled to indicate a direction along the evacuation route.

In one example the sensors are configured to continuously measure hazard parameters and continuously transmit the measured hazard parameters to the evacuation server. A hazard parameter may a parameter that is indicative of a hazard. The measured hazard parameters may be any one or more of: temperature, smoke, chemical composition or other parameter that may be indicative of a hazard.

The evacuation server is configured to predict the path of a hazard spreading through a building based on the measured hazard parameters in a plurality of sensors, and continuously control the emergency signs to avoid the path of a hazard. The evacuation server may continuously or at regular time intervals calculate an updated evacuation route and control the emergency signs to direct people along the calculated path.

The evacuation server may be configured to implement the method of evacuation as described. The evacuation server may be configured to implement any one or more features described. In one example, the evacuation server comprises at least a processor and a memory unit, wherein the processor may be configured to perform the functions, or the method as described. The memory may store computer readable and executable instructions defining the functions and/or method steps, wherein the processor is configured to execute the stored instructions.

The term “comprising” (and its grammatical variations) as used herein are used in the inclusive sense of “having” or “including” and not in the sense of “consisting only of.”

The term “building” used here refers to a structure that is used by people and/or animals. The term building should be understood to mean any structure where people gather for any activity. The term building can refer to public buildings such as for example hospitals, schools, libraries, museums government offices. The term building can also refer to any commercial structure such as for example office tower, warehouses, shopping centers, factories etc. The term building can also denote dwellings such as for example multi story apartments, multi-level houses, single level houses etc.

The term “hazard” as used herein refers to a situation that would present a danger to humans and animals in a building and would require evacuation. Hazard can refer to any dangerous situation that would require evacuation. Some examples include a fire or smoke accumulation or a chemical leak or a gas leak or a sewage leak in a building etc.

It is to be understood that, if any prior art information is referred to herein, such reference does not constitute an admission that the information forms a part of the common general knowledge in the art.

### BRIEF DESCRIPTION OF THE DRAWINGS

Various examples will now be described, by way of example, with reference to the accompanying drawings in which:

FIG. 1 illustrates a known static emergency sign.

FIG. 2 illustrates another known static emergency signs.

FIG. 3 illustrates an example evacuation system for guiding people out of a building.

FIG. 4 illustrates an example of a mesh network formed by the sensors.

FIG. 5 illustrates a schematic diagram of the evacuation server.

FIG. 6 illustrates a block diagram of components of the evacuation server.

FIG. 7 illustrates an example of emergency signs used as part of the evacuation system and activation of the sign.

FIG. 8 illustrates another example of emergency signs used as part of the evacuation system and activation of the sign.

FIG. 9 illustrates another example of emergency signs used as part of the evacuation system and activation of the sign.

FIG. 10 illustrates another example of emergency signs used as part of the evacuation system and activation of the sign.

FIG. 11 illustrates another example of emergency signs used as part of the evacuation system and activation of the sign.

FIG. 12 illustrates another example of emergency signs used as part of the evacuation system and activation of the sign.

FIG. 13 is a schematic diagram that illustrates the evacuation system 300 utilised in one floor of an apartment building.

FIG. 14 illustrates an additional detected hazard in the floor as per FIG. 13.

### DETAILED DESCRIPTION OF THE PREFERRED EMBODIMENTS

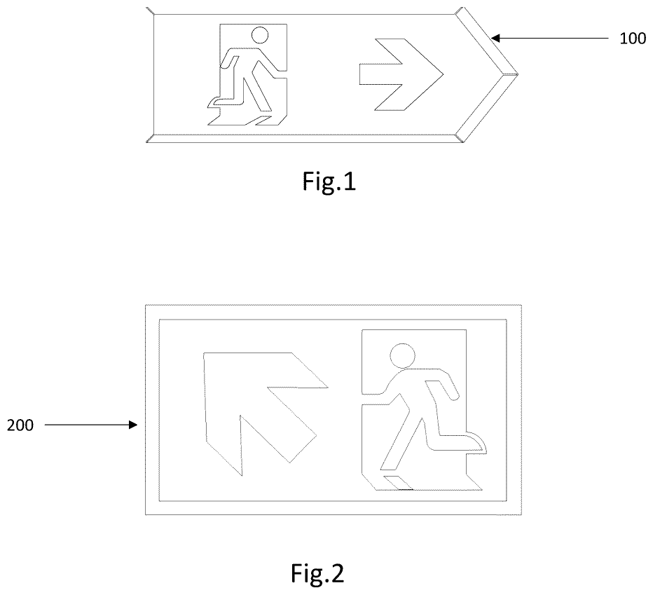

Currently used evacuation systems are static systems with static emergency signs. FIGS. 1, and 2 are illustrations of existing emergency signs. The illustrated emergency signs are exit signs. FIG. 1 illustrates an example directional sign 100 that points in the direction of an exit. Sign 200, as shown in FIG. 2 illustrates the direction of the exit is upstairs. These directional signs 100 and 200 are both static signs. Current evacuation systems also use binary sensors such as for example smoke alarms or sprinklers with temperature and/or smoke sensors. These binary sensors trip, e.g., detect a hazard only when a threshold has been exceeded. These current evacuation systems do not determine the location of a hazard and do not guide people away from any hazards. The current systems do not provide a clear evacuation path, often can have false triggers or false alarms and generally do not provide an efficient evacuation system.

The present invention relates to an evacuation system for guiding people out of a building in response to a detected hazard, while avoiding hazards in the building. The present invention further relates to an evacuation method for guiding people out of a building in response to a detected hazard while avoiding hazards in the building. The evacuation system and method may be automated.

The automated evacuation system provides a system that monitors sensor parameters to detect the occurrence of a hazard in real time and calculate evacuation path or paths to avoid the detected hazard and control emergency signs in a building to guide people along the calculated evacuation path. The evacuation path (or evacuation route) may be dynamically updated as new hazards are detected or if a detected hazard changes location. For example, a fire can spread or additional fires may ignite, and the evacuation system is configured to update the evacuation path or calculate new evacuation path (or paths) to avoid the detected hazards. The system further comprises emergency signs that are updated to direct or guide people along the evacuation path.

The present invention further relates to an evacuation method for guiding people out of a building during an evacuation, the evacuation method comprising the steps of: receiving sensor measurements from each of the sensors, determining if a hazard has occurred based on comparing if one or more of the hazard parameters within the sensor measurements exceeds a threshold, determining a location of the detected hazard, calculating an evacuation path if a hazard has occurred, wherein the evacuation path is a path to out of the building, controlling the one or more emergency signs to guide people along the calculated evacuation path. The method may be automated. The method may be executed continuously by the evacuation server. The method may include the steps of determining changes in the position of the hazard or movement of the hazard or new hazards forming and calculating an updated evacuation path or paths to avoid the hazards. The emergency lights may be actuated or controlled to illuminate to guide people to follow the updated evacuation path. The hazards may be any one or more of fires, smoke accumulation, chemical spills, gas leaks, sewage leaks etc. The system may be configured to detect other hazards.

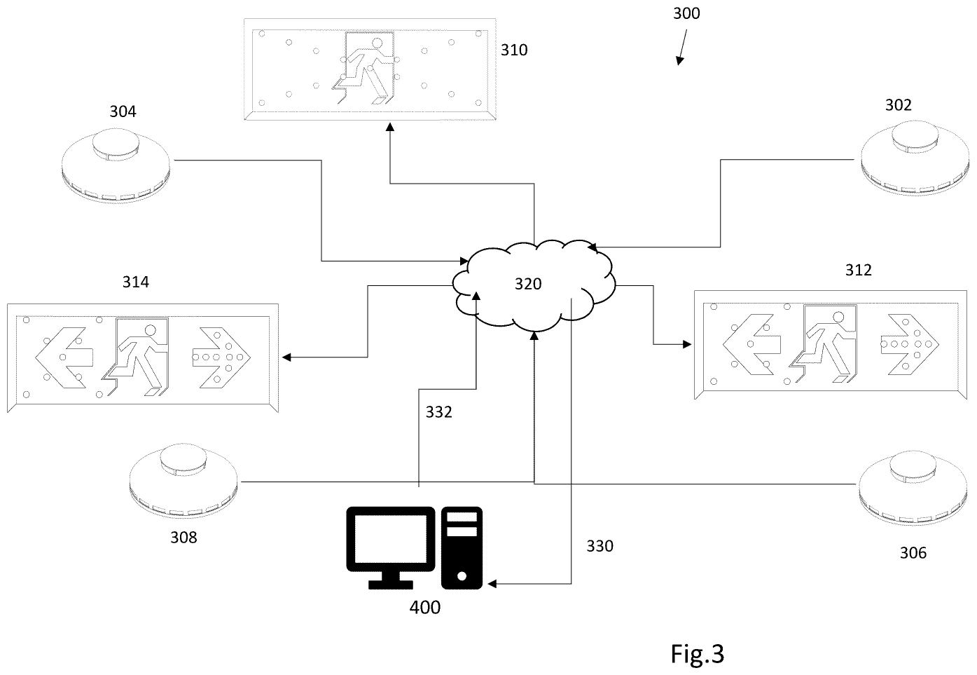

Referring to FIG. 3, an example form of an automated evacuation system is illustrated. FIG. 1 illustrates an automated evacuation system for guiding people out of a building during an evacuation, the evacuation system comprising: a plurality of sensors at predefined locations in a building, each of the sensors configured to measure hazard parameters, a plurality of emergency signs at predetermined locations within the building, an evacuation server operatively coupled to the plurality of sensors and the emergency signs, the evacuation server configured to: receive sensor measurements from each of the sensors, determine if a hazard has occurred based on comparing if one or more of the hazard parameters within the sensor measurements exceeds a threshold, determine a location of the detected hazard, calculate an evacuation path if a hazard has occurred, wherein the evacuation path is a path to out of the building, and, control the one or more emergency signs to guide people along the calculated evacuation path.

The system 300 comprises a plurality of sensors 302, 304, 306, 308. The sensors 302-308 may be located at predefined locations in a building and configured to measure one or more hazard parameters. The system 300 comprises a plurality of emergency signs 310, 312, 314, each located at predetermined locations within the building. The system 300 comprises an evacuation server 400 that is operatively coupled to each sensor 302-308 and each emergency sign 310-314. The evacuation server 400 is configured to wirelessly communicate with the sensors 302-308 and emergency signs 310-314 via the wireless network 320. The evacuation server is configured to receive sensor measurements, via the network, as denoted by signals 330. The evacuation server 400 is further configured to transmit control signals e.g., actuation signals to each of the emergency signs 310-314, via the wireless network 320 as denoted by signal 332.

The evacuation server 400 is configured to receive sensor measurements of hazard parameters or a signals indicative of a hazard parameter from each sensor 302-308. The evacuation server 400 is configured to process the sensor measurements, determine if a hazard has occurred and an evacuation is required, calculate an evacuation path to an exit while avoiding the detected hazard and provide a signal to control each emergency sign 310-314 to guide people along the evacuation path.

The evacuation system 300 comprises a plurality of sensors. The system 300 may comprise a plurality of the same type of sensor. Alternatively, the system 300 may comprise multiple different types of sensors. The sensors 302-308 each comprise a wireless communication interface, a sensing transducer and a power source. The wireless communication interface may be configured to communicate via any suitable communication network. In one example, each sensor 302-308 may comprise a Bluetooth or Wi-Fi communication interface or any other suitable communication interface. The sensing transducer is configured to sense a hazard parameter.

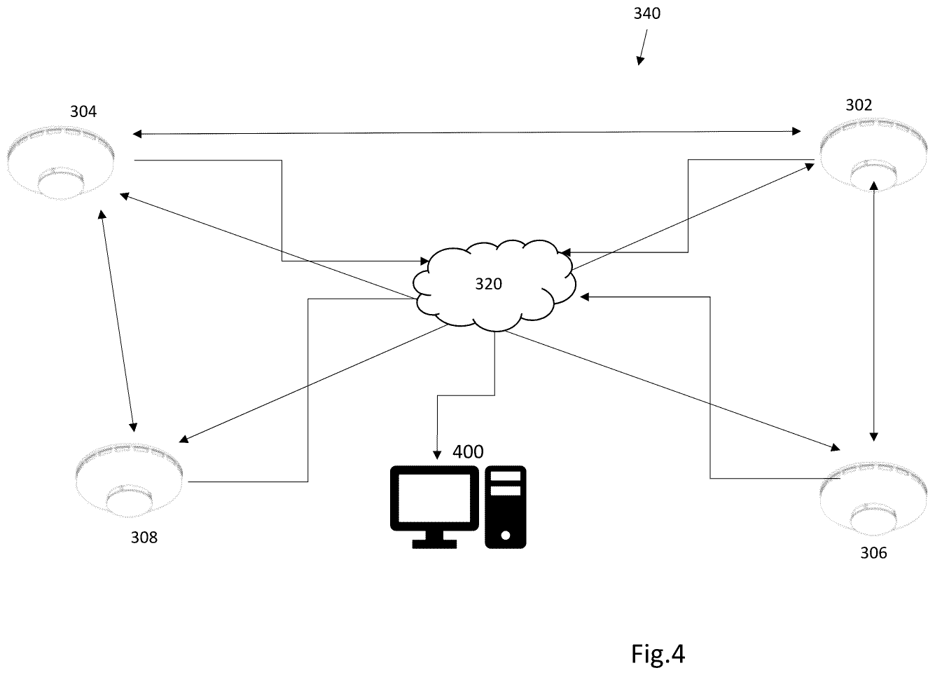

In one example form, the evacuation system 300 the sensors are arranged at predefined locations in the building and define a mesh network. FIG. 4 illustrates an example of the mesh network 340. The sensors 302-308 may be interconnected as shown in FIG. 4 and the sensors may be configured to transmit sensed parameters through each sensor to the server 400 or directly to the server 400. The mesh network 340 architecture allows the sensors 302-308 to communicate via each other even if part of a network is not available within a specific area of a building adjacent a sensor. The mesh network architecture provides certainty that measured hazard parameters are transmitted back to the evacuation server 400. Optionally, the emergency signs may also be capable of communication with each other and may be arranged in a mesh network.

The sensors 302-308 may be configured to wirelessly communicate with each other via an appropriate communication protocol. In one example the sensors 302-308 may be configured to wirelessly communicate with each other and the evacuation server 400 using the LoRA protocol. Additionally, the sensors 302-308 may also communicate via Wi-Fi. Other networking protocols are contemplated. For illustration four sensors are illustrated. It should be understood the system 300 can comprise a large number of sensors spread across the building. The system is scalable to allow sensors and signs to be added or removed. New signs and sensors can be paired with the server to wirelessly communicate with the server 400.

The sensors 302-308 are positioned and mounted at predefined locations within a building. In one example the number of sensors and types of sensors required in a building may be stipulated in law. The predefined locations of the sensors may also be stipulated by law.

Each sensor 302-308 is configured to sense a hazard parameter. Hazard parameters are parameters that may be indicative of a hazard (or hazard situation). A hazard situation is an event or situation that would signify the building needs to be evacuated such as for example a fire or smoke accumulation or a chemical leak or a gas leak or a sewage leak in a building or any other event that would require evacuation. The hazards parameter sensed by the one or more sensors are one or more of: temperature, smoke, gas (e.g., propane, methane, natural gas), toxic chemicals (e.g., arsenic, hydrocarbons, esters or other toxic chemicals) or heat flux.

In one example the evacuation system 300 may comprise smoke detectors and temperature sensors. In another example the system 300 comprises smoke detectors, temperature sensors and gas sensors to sense natural gas or hydrocarbons. In another example form, each sensor of the evacuation system 300 may comprise a multi sensing transducer. For example, each sensor may be a combined smoke detector and temperature sensor. The system 300 may further comprise other sensors. Each of the sensors is configured to transmit measured hazard parameters to the evacuation server 400. The sensors may be adapted to continuously transmit measured hazard parameters to the server 400. In one example, each sensor may be adapted to transmit measured hazard parameters to the server 400 in real time.

The evacuation system 400 comprises a plurality of emergency signs positioned throughout the building. The emergency signs may be positioned at predefined locations. The position of the emergency signs and the types of emergency signs used may be defined by appropriate laws. The emergency signs 310-314 indicate the way to an exit of a building, e.g., an emergency exit in the building.

Each emergency sign 310-314 may comprise controllable indicia to guide people. The evacuation server 400 may be configured to transmit control signals to each emergency sign to activate the indicia to indicate a direction of travel. The indicia may be activated to correspond to the determined safe evacuation path by the evacuation server 400.

In this embodiment, the evacuation system 400 is arranged to continuously monitor hazard parameters from the sensors, determine if a hazard has occurred requiring evacuation, calculate an evacuation path and control a plurality of emergency signs to activate indicia on the signs to guide people along the evacuation path.

In one example embodiment, the evacuation server 400 may be implemented by a computer having appropriate components such as for example a processor, a memory and a user interface e.g., a display. The server 400 may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The server 400 (computer) may be appropriately programmed to implement the invention and implement a method of evacuation as described herein.

In one example the evacuation server 400 may be located within the building. The server 400 may be an on-premises server. Alternatively, the server 400 may be a cloud-based server. The server 400 may interact with client devices e.g., the sensors and the emergency signs. The evacuation server 400 may further be configured to communicate with one or more remote display screens or other remote device such as mobile devices of the people in the buildings or mobile devices of rescue authorities etc. The server 400 may also be adapted to communicate with emergency authorities such as the fire department if an evacuation event is detected and the system 300 has to be activated to guide people out of the building. The server 400 can for reporting and record keeping purposes display information related to an evacuation event on a display or transmit this information to one or more remote systems.

As shown in FIG. 5, there is a shown a schematic diagram of an evacuation server 400 which is arranged to be implemented as an example of the evacuation system 300. In this embodiment comprises a server 400 which includes suitable components necessary to receive, store and execute appropriate computer instructions. The components may include a processor 402 (or processing unit 402), including one or more of a Central Processing Unit (CPU), Math Co-Processing Unit (Math Processor), Graphic Processing Unit (GPUs) or Tensor processing unit (TPUs) for tensor or multi-dimensional array calculations or manipulation operations, read-only memory (ROM) 404, random access memory (RAM) 406, and input/output devices such as disk drives 408, input devices 410 such as an Ethernet port, a USB port, etc.

Display 412 such as a liquid crystal display, a light emitting display or any other suitable display. The display 412 or user interface 412 may present measured sensor data, the calculated evacuation path and the locations of the detected hazards (hazard zones or areas). The server 400 may be configured to log evacuation incidents, the evacuation paths, the detected hazards and location of the hazards for reporting. The server 400 may also be arranged to detect zones or areas which have detected hazards, and thus based on the pathways around the zones or areas, and the nature of the hazards, mark the zone or area as a hazard. The display 412 may be a remote display or a separate display or may integrated with the server 400. The display 412 may also be a screen of a user device such as for example a tablet or mobile device etc.

The server 400 may comprise appropriate communication links 414 or communication interfaces or communication modules. The communications link may comprise one or more communication interfaces or communication modules. The evacuation server 400 may include instructions that may be included in ROM 404, RAM 406 or disk drives 508 and may be executed by the processing unit 402. There may be provided a plurality of communication links 414 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The evacuation server 400 may include storage devices such as a disk drive 408 which may encompass solid state drives, hard disk drives, optical drives, magnetic tape drives or remote or cloud-based storage devices. The server 400 may use a single disk drive or multiple disk drives, or a remote storage service. The server 400 may also have a suitable operating system which resides on the disk drive or in the ROM of the server 400. The server 400 may comprise additional databases to store various information. The server 400 may be adapted to communicate with appropriate government websites that store building plan information and may access building plan information such as for example blueprints etc.

The evacuation server 400 may also provide the necessary computational capabilities to operate or to interface with a machine learning network, such as a neural networks, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time. The evacuation server 400 may comprise computational capabilities to operate other artificial intelligence (AI) models that may be programmed to for various functions. The AI Models may be fully trained, partially trained or untrained. The evacuation server 400 may further include appropriate required data libraries and other tools that may be used to train, update and/or optimise the learning networks or AI models. In one example the server 400 may comprise a neural network of AI model repository 416 that may be accessible by at least the processor to initiate and implement a stored neural network or AI model.

The evacuation server 400 may further comprise a building model database 420 configured to store one or more building models. The building models comprise an electronic or virtual building model of the building. The database 420 may store models of multiple buildings. The server 400 may comprise a sensor location database 422 that includes the locations of each sensor in the building. The server 400 may further comprise an emergency sign location database 424 includes the location of each emergency sign in the building. The building model may comprise the locations of the sensors and the emergency signs.

Optionally, the evacuation server 400 may be configured to generate a model of the building by accessing one or more building plans and by accessing and utilising the locations of the sensors from the sensor location database and the locations of the emergency signs from the emergency sign location database.

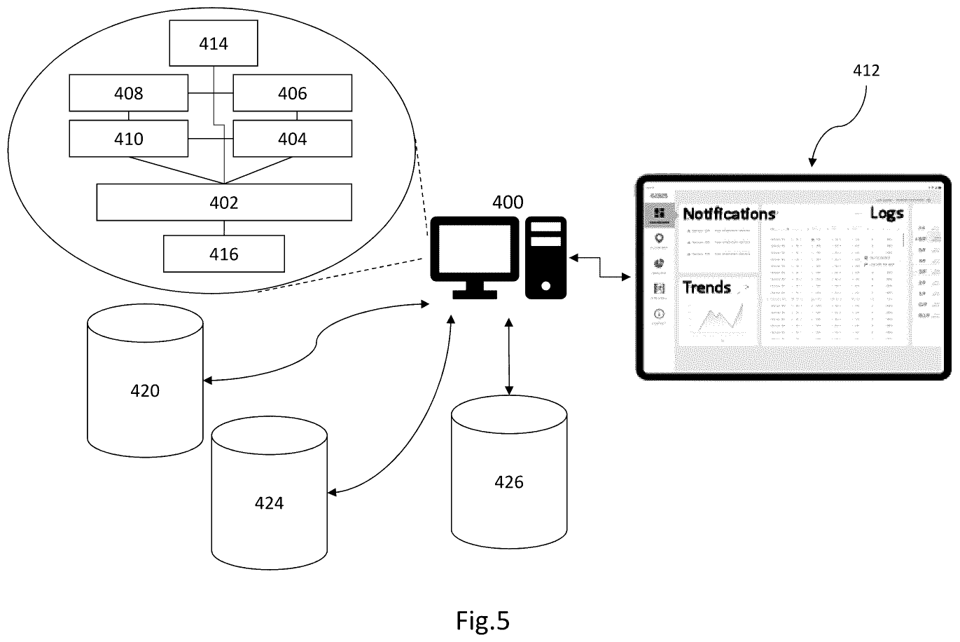

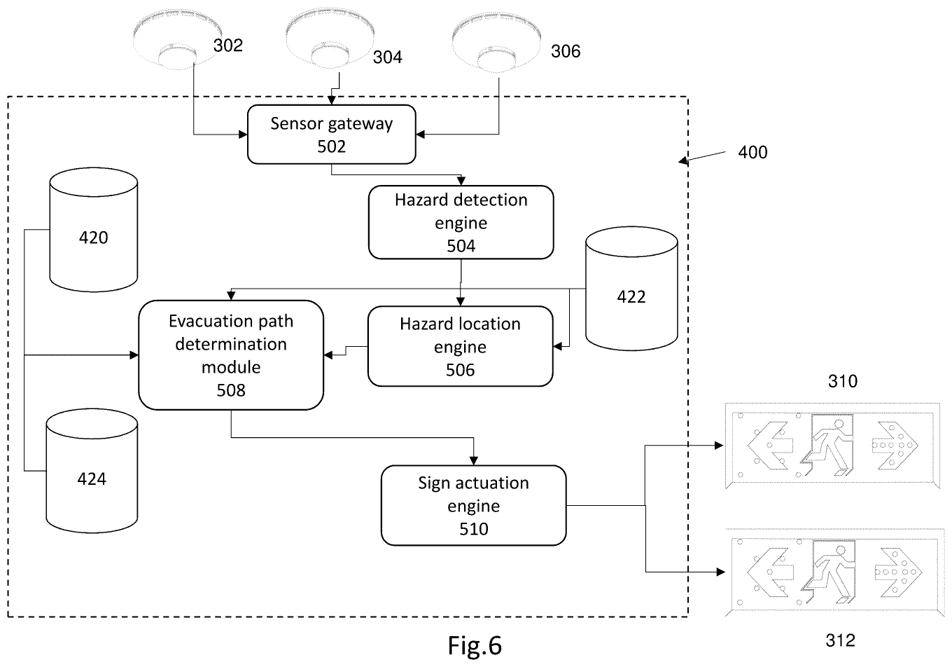

In this embodiment, the evacuation server 400 may be part of the evacuation system 300 or may be the evacuation system 300. FIG. 6 illustrates a high-level block diagram of an evacuation server 400. FIG. 6 may illustrate a block diagram of the software architecture, including the various software components. The components shown in FIG. 6 may be software elements or hardware elements or a combination thereof.

Referring to FIG. 6, the evacuation server 400 comprises a sensor gateway 502. The sensor gateway 502 is configured to receive sensor measurements from the sensors. The sensor measurements comprise a hazard parameter. The server 400 further comprises a hazard detection engine 504. The hazard detection engine 504 is configured to process the sensor measurements and detect a hazard if the one or more measured hazard parameters exceeds a threshold or if one or more measured hazard parameters are trending to exceeding a threshold. The evacuation server 400 may comprise a hazard location engine 506 configured to determine the location of a hazard within the building. The hazard location engine 506 may be configured to access the sensor location database 422 to determine the location of the detected hazard.

In one example the hazard location engine 504 is configured to determine a location of the hazard by identifying the one or more sensors that detected the hazard and identifying the location of the one or more sensors. The location of the hazard corresponds to the location of the sensors that detected the hazard.

The evacuation server 400 comprises an evacuation path determination module 508 configured to calculate the evacuation path that avoids the hazard location or an entire hazard zone. The evacuation path determination module 508 is configured to access the building model, the sensor locations and the sign locations from the respective databases 420, 422, 424 to calculate an evacuation path. The evacuation path may be recalculated as the location of the hazard is updated. The evacuation path determination module 508 is configured to calculate the evacuation path is calculated based on a shortest point algorithm between the various emergency signs, wherein each emergency sign defines a waypoint in the evacuation path. The evacuation server 400, more specifically the module 508 is configured to access or generate an electronic model of the building, wherein the model includes the sensors and the emergency signs and their respective locations. The model further including one or more exits of the building. The module 508 is configured to calculate an evacuation path through the building to the one or more exits using the model of the building. The evacuation server 400 is configured to plot the location of one or more detected hazards on the model and calculate an evacuation path to avoid the hazards. Additionally, where an entire zone or area may have numerous hazards, or if the nature of the hazards would indicate that an entire area or zone would be considered hazardous (e.g. a gas leak or release of hazardous chemicals), the evacuation server 400 may also be configured to mark the entire area or zone as a hazard zone or area, and thus when calculating the path to avoid the hazards, the server may determine a path that completely avoids the hazard zone or area. A number of methods are possible to mark the entire zone or area as hazardous under certain conditions. For example, all data from the sensors in the entire zone or area may be overridden by the server 400 as meeting or exceeding a hazardous threshold, even if some of the individual sensors within the zone or area are still detecting normal readings.

The evacuation server 400 may comprise a sign actuation engine 510 that is configured to generate actuation signals. The actuation signals are transmitted to the emergency signs 310, 312 to activate and control the emergency signs to guide people along the calculated evacuation path. The actuation signals cause the indicia on the emergency signs to be activated to direct people along the determined evacuation path.

Optionally in one example the evacuation server 400 may be configured to calculate a plurality of evacuation paths to an exit while avoiding one or more detected hazards in the building or one or more hazard zones. The evacuation path determination module 508 may be configured to dynamically update the evacuation path. The sign actuation engine 510 may be configured to control the emergency signs to guide people along the updated evacuation path.

In operation the evacuation server 400 is configured to determine if a hazard has occurred based on one or more of: a hazard parameter exceeds a threshold, a hazard parameter is detected for a threshold time or detected for longer than a threshold time, a hazard parameter exceeds a threshold for at least a threshold time.

The evacuation server 400 may be further configured to monitor the location of the detected hazard. The location of the hazard may be determined based on the location of the sensors that detected the hazard. The server 400 is further configured to determine if the hazard has moved to another location or a hazard is detected is at another location within the building. In many situations a hazard may move or spread. For example, a fire can spread across a building, or a gas leak can cause gas to build up through a floor. The system 300 is configured to avoid the location of the hazard. The server 400 is configured to track the location of the detected hazard and update the evacuation path or calculate a new evacuation path that avoids the location of the detected hazards.

In one example of operation the evacuation server 400 is configured to continuously detect hazard parameters from each sensor in the building. The location of the detected hazard may be correlated to the locations of the sensors that sensed hazard parameters corresponding to the hazard. The server is configured to calculate if a hazard has occurred. If a hazard has occurred, the server 400 is configured to monitor the location of the detected hazard and track the spread of the hazard through the building based on the locations of the sensors that have detected hazard parameters indicative of a hazard. The server 400 may be configured to continuously update the evacuation path to avoid the detected hazard and avoid the changing location of the hazard. The server 400 may be further configured to continuously control each of the emergency signs to guide people along the updated evacuation path.

Optionally, the evacuation server 400 may be configured to predict a path of a hazard through the building by extrapolating two or more hazard parameter readings from two or more sensors. The server 400 may be configured to update the evacuation path to avoid locations along the predicted path of the hazard. The server 400 may be further configured to control the emergency signs to guide people along the updated evacuation path.

Additionally, the evacuation server 400 may be arranged to predict a path through the building which will avoid entire regions, areas or zones due to these regions, areas or zones being marked as hazardous. The server 400 may be configured to update the evacuation path to avoid these regions, areas or zones along the predicted path of the hazard. The server 400 may be further configured to control the emergency signs to guide people along the updated evacuation path.

The automated evacuation system 300 and the evacuation server may operate in real time to receive sensor measurements and determine a hazard or predict a hazard is likely to occur, determine an evacuation path in response if an evacuation is required due to a determined hazard or a prediction of a hazard will occur based on the sensor measurements.

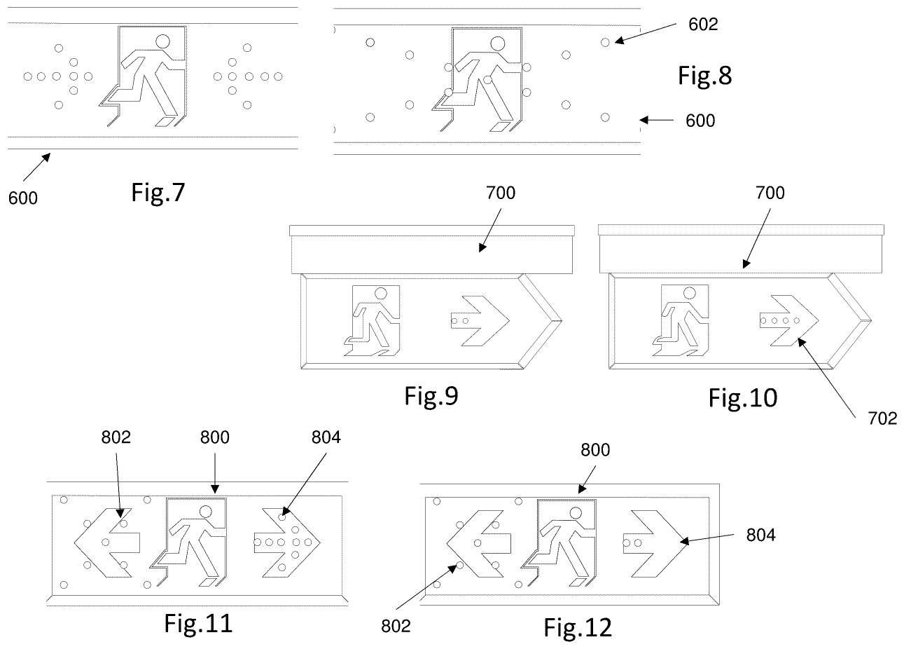

The emergency signs include actuatable indicia. The indicia may be visual indicia such as for example LEDs or other lights. The lights can be illuminated in a specific sequence to communicate directions to people. The directions that are communicated correspond to the evacuation path. There are at least three types of emergency signs. The types may be specified by law. FIGS. 7 to 12 illustrate examples of emergency signs used as part of the evacuation system 300 and the illumination of these. FIGS. 7 and 8 illustrate an emergency sign 600 that would be positioned adjacent or on a door. FIG. 7 illustrates the door is safe to go through and may have one or more illuminating arrows that would point to the centre of the door to indicate that the door is safe for users to access. FIG. 8 illustrates an illuminated cross 602 indicating the door is not safe to go through.

FIGS. 9 and 10 illustrate a sign 700 that may be located in a corridor or at a corner. The arrow indicates the direction to travel. FIGS. 9 and 10 illustrates the arrow 702 is illuminated due to an actuation signal from the evacuation server 400. The arrow being illuminated denotes the path is safe and directs people along the arrow. FIGS. 11 and 12 illustrate an emergency sign 800 that may be positioned at a T junction in a building. The T junction sign 800 illustrates two directions of travel. The direction where a hazard is detected is illuminated with a cross 802. The “safe” side i.e., the direction with no detected hazard may be illuminated by an arrow 804. The cross and arrow may change, or the sign may illustrate double arrows denoting both directions are safe or double crosses indicating that both directions are not safe and a person should turn back. The crosses and arrows may be illuminated by a suitable colour scheme such as for example red for the cross and green for the arrow. This provides an intuitive guide to people following the signs of what directions are safe and what directions have a hazard. The crosses may flash. The arrows may be illuminated to slowly extend along its length.

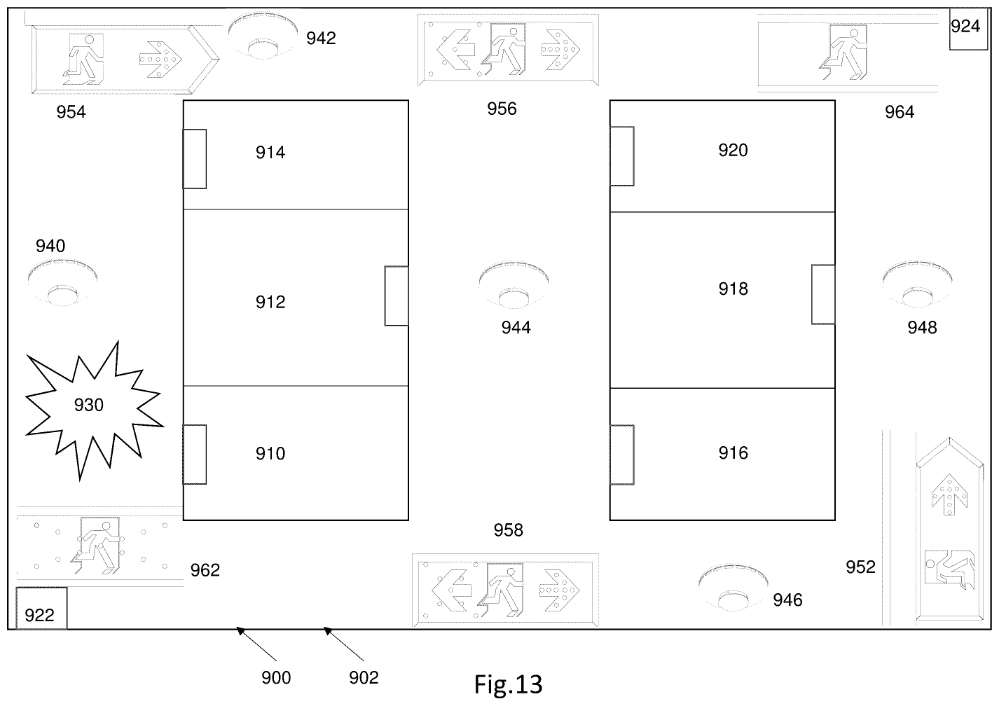

FIG. 13 is a schematic diagram that illustrates the evacuation system 300 in one floor 902 of an apartment building 900. FIG. 13 will be used to explain an example operation of the evacuation system 300. The floor 902 includes six apartments labelled 910, 912, 914, 916, 918, 920. The floor includes two exits 922 and 924. Sensors 940, 942, 944, 946 and 948 may be disposed at various locations on the floor within the hallways of the building floor 902. The sensors 940-948 may be adapted to sense hazards such as smoke or fire. The sensors may be similar in structure to sensors 302-308 described. The floor 902 also comprises a plurality of emergency signs 952, 954, 956 and 958. Two additional emergency signs illustrating a door are positioned adjacent the exits 922, 924. The exit signs are 962 and 964. In the illustrated example for clarity, the server 400 is not illustrated, but it should be understood the sensors wirelessly communicate with the server 400 and the server 400 provides control signals to the emergency signs.

Sensor 940 may be configured to detect a hazard 930. The hazard 930 may be a fire. The fire 930 may have been detected due to a temperature increase or an increase in smoke detected by the sensor 940. The evacuation server 400 may receive the measured hazard parameters and determine if the measured hazard parameters (temperature and/or smoke) exceed a threshold. The evacuation server 400 determines the apartments need to evacuate. The evacuation server has plotted an evacuation path to the exit 924 since the other exit 922 is too close to the hazard 930 (the fire). The evacuation path may be different for each resident of each apartment. However, the evacuation path determined leads to exit 924.

The evacuation server 400 is configured to transmit control signals to each of the emergency signs 952-962 and control illumination to guide people along the evacuation path toward exit 924. The exit sign 962 has a cross illuminated on it indicating there is danger since it is too close to fire 930. Similarly, signs 956 and 958 indicate a cross in the direction of the fire 930. The emergency signs are activated to visually indicate by lights the safe direction for evacuation.

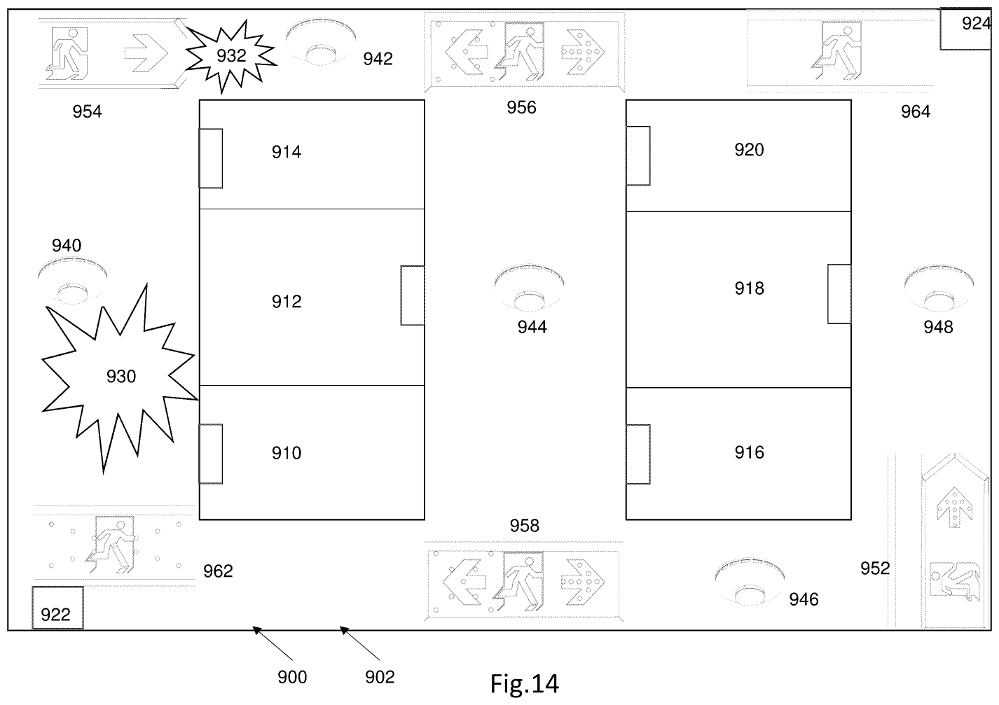

FIG. 14 illustrates a changed condition. A new fire 932 has started and was detected by sensor 942. The evacuation system 400 is configured to determine the location of the two fires 930 based on the location the sensors 940 and 942 that detected the fires. The location of the hazard may correspond to the location of the sensor that sensed the hazard. Multiple sensors may detect a hazard and the server 400 may determine the hazard is large and extends across multiple locations.

Referring to FIG. 14, in response to the new fire 932 being detected emergency sign 954 has been switched off by the server indicating there is a risk and a hazard present. The other emergency signs direct people toward exit 924. The server 400 may also activate audible evacuation alarms etc.

The evacuation server 400 may be configured to filter out spikes in readings to account for errors due to people cooking or other conditions that may cause a false positive. The server 400 may implement a neural network to recognise hazard parameter measurements that are indicative of a hazard and filter out other false positives. In one example, the server 400 may determine the presence of a hazard if the hazard parameter value exceeds a threshold for a threshold time. The evacuation server 400 may also be configured to detect one or more hazard parameters, determine if the detected hazard parameter has reached a dangerous level. If so, then the server 400 may update the evacuation path to avoid the location of the sensor that detected the hazard parameter has reached a dangerous level. The server 400 may further control the emergency signs to guide people along the updated evacuation path.

In one example the server 400 may detect smoke at a height e.g., at 3 m. If the server 400 detects smoke via one or more sensors at 2 m or below, the server may indicate a hazard has occurred and control the emergency signs to direct people away from the accumulated smoke. The server 400 may further utilise neural networks of AI models to process hazard parameter measurements continuously to recognise patterns. For example, the server 400 may be configured to recognise a pattern of increasing temperature at power sockets or an increasing gas concentration around gas mains valves. The server 400 may be configured to predict the likely occurrence of a hazard based on these patterns of trends. If the server 400 determines a hazard is likely to occur the server may determine an appropriate evacuation path, generate an evacuation alarm and control the emergency signs to direct people along the evacuation path. The server 400 may pre-emptively raise an alarm based the trend of the measured hazard parameter.

The server 400 may log measured hazard parameters, number of hazards, types of hazards, locations of the hazards etc. in a log. The log may be accessible by authorities such as for example the fire department or the police in order to run analytics and determine changes or improvements or repairs that may be needed.

The evacuation system 300 as described herein is advantageous because it provides continuous monitoring of hazard parameters. The monitoring may be done in real time. The system 300 determines a safe evacuation path to avoid detected hazards and controls emergency lights to direct people safely away. The system provides an optimal evacuation routes and these routes are dynamically adjusted to avoid new hazards or spreading hazards. The system provides an efficient evacuation system that reduces the likelihood of false alarms and false evacuations. The system further does not require wires for installation as the sensors and emergency signs communicate wirelessly. The system is modular and allows additional sensors or signs to be added or removed providing flexibility and scalability.

Although not required, the embodiments and examples described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include stand-alone computers, network computers and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An automated evacuation system for guiding people out of a building during an evacuation, the evacuation system comprising:
a plurality of sensors at predefined locations in a building, each of the sensors configured to measure hazard parameters,
a plurality of emergency signs at predetermined locations within the building,
an evacuation server operatively coupled to the plurality of sensors and the emergency signs, the evacuation server configured to:
receive sensor measurements from each of the sensors,
determine if a hazard has occurred based on comparing if one or more of the hazard parameters within the sensor measurements exceeds a threshold,
determine a location of the detected hazard,
calculate an evacuation path if a hazard has occurred, wherein the evacuation path is a path to out of the building, and;
control the one or more emergency signs to guide people along the calculated evacuation path.

2. An automated evacuation system as in claim 1, wherein each emergency sign comprises comprising controllable indicia to guide people, wherein the evacuation server is configured to transmit control signals to each emergency sign to activate the indicia to indicate a direction of travel corresponding to the calculated evacuation path.

3. An automated evacuation system as in claim 1, wherein the evacuation system comprises a plurality of sensors, and the sensors are arranged at predefined locations in the building and define a mesh network.

4. An automated evacuation system as in claim 3, wherein the sensors are configured to wirelessly communicate with each other and the evacuation server, wherein the sensors are configured to communicate with each other using the LoRA protocol.

5. An automated evacuation system as in claim 1, wherein the evacuation server is configured to:
access or generate an electronic model of the building, wherein the model includes the sensors and the emergency signs and their respective locations,
the model further including one or more exits of the building, and;
calculate an evacuation path through the building to the one or more exits using the model of the building.

6. An automated evacuation system as in claim 5, wherein the evacuation server is configured to plot the location of one or more detected hazards on the model and calculate an evacuation path to avoid the hazards.

7. An automated evacuation system as in claim 1, wherein the evacuation server is configured to calculate a plurality of evacuation paths to an exit while avoiding one or more detected hazards in the building.

8. An automated evacuation system as in claim 1, wherein the evacuation server comprises:
a sensor gateway configured to receive sensor measurements comprising a hazard parameter,
a hazard detection engine configured to process the sensor measurements and detect a hazard if the one or more measured hazard parameters exceeds a threshold or if one or more measured hazard parameters are trending to exceeding a threshold,
a hazard location engine configured to determine the location of a hazard within the building,
an evacuation path determination module configured to calculate the evacuation path that avoids the hazard location, and;
a sign actuation engine configured to generate actuation signals that are transmitted to the emergency signs to activate and control the emergency signs to guide people along the calculated evacuation path.

9. An automated evacuation system as in claim 8, wherein the evacuation path determination module is configured to calculate the evacuation path is calculated based on a shortest point algorithm between the various emergency signs, wherein each emergency sign defines a waypoint in the evacuation path.

10. An automated evacuation system as in claim 8, wherein the evacuation path determination module is configured to dynamically update the evacuation path and control the emergency signs to guide people along the updated evacuation path.

11. An automated evacuation system as in claim 10, wherein the hazard location engine is configured to determine a location of the hazard by identifying the one or more sensors that detected the hazard and identifying the location of the one or more sensors, wherein the location of the hazard corresponds to the location of the sensors that detected the hazard.

12. An automated evacuation system as in claim 8, wherein the system comprises:
a building model database configured to store one or more building models, wherein the building model comprises an electronic or virtual building model,
a sensor location database that includes the locations of each sensor in the building,
an emergency sign location database that includes the location of each emergency sign in the building, and;
wherein the model comprises the locations of the sensors and the emergency signs.

13. An automated evacuation system as in claim 12, wherein the evacuation server is configured to generate a model of the building by accessing one or more building plans and by accessing and utilising the locations of the sensors from the sensor location database and the locations of the emergency signs from the emergency sign location database.

14. An automated evacuation system as in claim 1, wherein the evacuation server is configured to determine if a hazard has occurred based on one or more of:
a hazard parameter exceeds a threshold,
a hazard parameter is detected for a threshold time or detected for longer than a threshold time, or;
a hazard parameter exceeds a threshold for at least a threshold time.

15. An automated evacuation system as in claim 1, wherein the evacuation server is configured to:
monitor the location of the detected hazard,
determine if the hazard has moved to another location or a hazard is detected is at another location within the building, and;
update the evacuation path or calculate a new evacuation path that avoids the location of the detected hazards.

16. An automated evacuation system as in claim 1, wherein the evacuation server is configured to:
continuously detect hazard parameters from each sensor,
calculate if a hazard has occurred,
monitor the location of the detected hazard and track the spread of the hazard through the building based on the locations of the sensors that have detected hazard parameters indicative of a hazard, and;
continuously update the evacuation path to avoid the detected hazard and avoid the changing location of the hazard,
continuously control each of the emergency signs to guide people along the updated evacuation path.

17. An automated evacuation system as in claim 16, wherein the system operates in real time to receive sensor measurements and determine a hazard or predict a hazard is likely to occur, determine an evacuation path in response if an evacuation is required due to a determined hazard or a prediction of a hazard will occur based on the sensor measurements.

18. An automated evacuation system as in claim 1, wherein the evacuation server is configured to:
predict a path of a hazard through the building by extrapolating two or more hazard parameter readings from two or more sensors,
update the evacuation path to avoid locations along the predicted path of the hazard, and;
control the emergency signs to guide people along the updated evacuation path.

19. An automated evacuation system as in claim 1, wherein the hazard parameter sensed by the one or more sensors are one or more of:
temperature,
smoke,
gas,
toxic chemical, or
heat flux.

20. An automated evacuation system as in claim 1, wherein the evacuation server is configured to:
detect one or more hazard parameters,
determine if the detected hazard parameter has reached a dangerous level,
update the evacuation path to avoid the location of the sensor that detected the hazard parameter has reached a dangerous level, and;
control the emergency signs to guide people along the updated evacuation path.
